(19) United States
(12) Patent Application Publication
(10) Pub. No.: US 2014/0234791 A1
(43) Pub. Date: Aug. 21, 2014

(54) DECORATIVE BOTTLE CANDLE CONTAINER

(71) Applicants: Brian House, Hartford, CT (US); Matthew House, Hartford, CT (US)

(72) Inventors: Brian House, Hartford, CT (US); Matthew House, Hartford, CT (US)

(21) Appl. No.: 13/772,880

(22) Filed: Feb. 21, 2013

(51) Int. Cl. F21V 35/00; C11C 5/02; B26D 1/00; C11C 5/00

(52) U.S. Cl. CPC F21V 35/003; C11C 5/006; C11C 5/02; B26D 1/00
USPC 431/291; 83/54; 53/452

(57) ABSTRACT

A candle container is provided including a generally hollow cylindrical base having a cavity configured to retain a candle. A lid is removably coupled to the base. The lid has a first portion adjacent a first end and a second portion near a second end. The first portion of the lid is generally complementary to the base. An insert is adhered to an interior surface of the first portion of the lid. The insert extends generally beyond a first end of the lid such that when the lid is attached to the base, a portion of the seal is received within the cavity of the base.

### BACKGROUND OF THE INVENTION

Exemplary embodiments of this invention generally relate to candles and, more particularly, to a candle formed within a decorative bottle container.

Candles are well known and are generally used as a light source during emergency situations, such as when electrical power is lost for example. In addition, candles are also used for decorative purposes. Candles are generally available in a variety of scents and colors and may add ambiance to a room or other setting while providing a scented odor during the burning of the candle.

Candles generally include a wick arranged at a center point of a wax body. Some candles, such as taper candles for example, are intended for use with a separate candle holder. Other candles have decorative shapes, or may be housed in a decorative container. Some candles are arranged within a bottom portion of a recycled glass bottle, such as a beer bottle or wine bottle for example. However, these candles generally do not have an aesthetically pleasing appearance when the candle is not in use.

### BRIEF DESCRIPTION OF THE INVENTION

According to one embodiment of the invention, a candle container is provided including a generally hollow cylindrical base having a cavity configured to retain a candle. A lid is removably coupled to the base. The lid has a first portion adjacent a first end and a second portion near a second end. The first portion of the lid is generally complementary to the base. An insert is adhered to an interior surface of the first portion of the lid. The insert extends generally beyond a first end of the lid such that when the lid is attached to the base, a portion of the seal is received within the cavity of the base.

According to an alternate embodiment of the invention, a candle container is provided including a housing having a generally hollow cylindrical base configured to receive a candle and a lid removably coupled to the base. The lid has a first portion adjacent a first end and a second portion near a second end. The first portion is generally complementary to the base. A removable cover is coupled to the second end of the lid. A partition is arranged between the first portion and the second portion of the lid such that a generally hollow compartment exists between partition and the second end of the lid.

According to yet another embodiment of the invention, a method of manufacturing a candle container is provided including cutting a bottle into a base and a lid having a first portion and a second portion. A candle is arranged within the cavity of the base. An insert is mounted to the first portion of the lid.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of a candle container according to an embodiment of the invention;

FIG. 2 is another front view of a separated base and lid of a candle container according to an embodiment of the invention;

FIG. 3 is a partial cross-sectional view of a lid of a candle container according to an embodiment of the invention;

FIG. 4 is a cross-sectional view of an assembled base and lid of a candle container according to an embodiment of the invention;

FIG. 5 is a partial cross-sectional view of a lid of a candle container according to another embodiment of the invention;

FIG. 6 is a cross-sectional view of a base of a candle container according to an embodiment of the invention; and

FIG. 7 is a top view of a base of the candle container according to an embodiment of the invention.

The detailed description explains embodiments of the invention, together with advantages and features, by way of example with reference to the drawings.

### DETAILED DESCRIPTION OF THE INVENTION

Referring now to the FIGS., a candle container 20 according to various embodiments of the invention is illustrated. The candle container 20 includes a container or housing 22 having a separable and complementary base 24 and lid 26. The housing 22 may be formed from a glass or other material. In one embodiment, the base 24 of the housing 22 includes a generally hollow elongated cylinder having a closed first end 28 and an open second end 30. The lid 26 is generally non-uniform in shape over its length such that the lid 26 has a first portion 32 adjacent a first end 34 and a distinct second portion 36 adjacent a second, opposite end 38. In one embodiment, the first portion 32 of the lid 26 has a generally semi-spherical shape and the second portion 36 has a generally narrow cylindrical shape. The diameter of the lid 26 near the first end 34 may be substantially larger than the diameter of the lid 26 taken near the second end 38. The diameter of the lid 26 at the first end 34 is generally equal to the diameter of the second, open end 30 of the base 24. In one embodiment, the housing 22 of the candle container 20 is configured to appear as a seamless, unaltered bottle when the lid 26 is positioned adjacent the base 24. Exemplary bottles that may be used to form the candle container 20 include, but are not limited to, wine, champagne, beer, and liquor bottles for example.

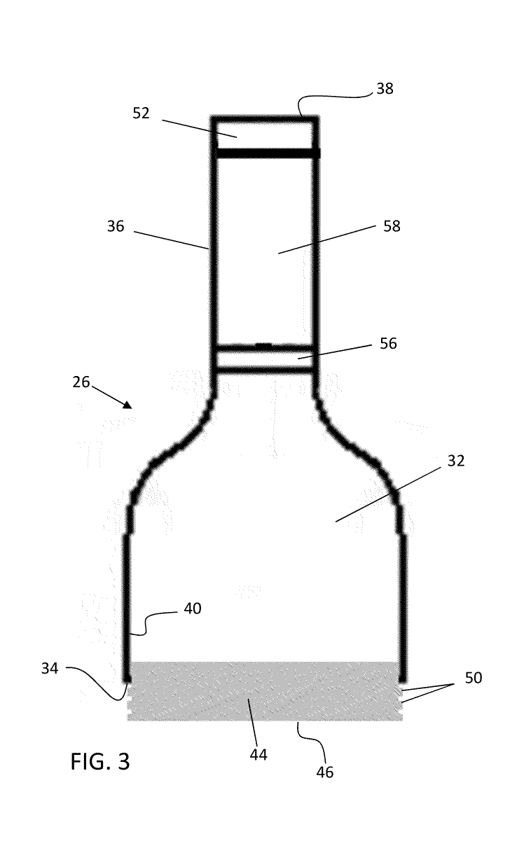

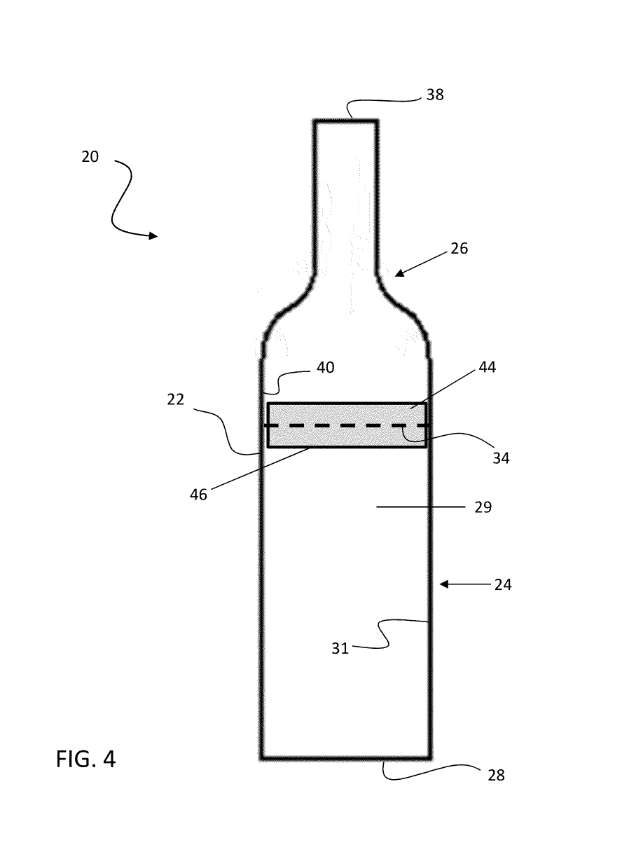

Referring now to the non-limiting embodiment illustrated in FIG. 3, an insert 44 may be mounted about the circumference of an interior surface 40 of the lid 26, such as with an adhesive for example. In one embodiment, the insert 44 may be formed from a wood veneer. In another embodiment, the insert 44 is generally formed from a deformable, elastic material including, but not limited to, plastic, silicone, rubber or a combination thereof for example. An end 46 of the insert 44 extends beyond the first end 34 of the lid 26. When the lid 26 is positioned adjacent the second end 30 of the base 24, the end 46 of the insert 44 is received within the hollow cavity 29 of the base 24. The insert 44 is configured to contact an interior surface 31 of the base 24 and vertically align the lid 26 relative to the base 24 (FIG. 4). In one embodiment, at least one protrusion 50, such as a fin for example, extends outwardly about the circumference of the insert 44, adjacent end 46. In such embodiments, the protrusions 50 on the insert 44 are configured to operably couple the lid 26 to the base 24 such that a minimum force must be applied to the lid 26 in a direction away from the base 24 to disconnect the lid 26 therefrom. In one embodiment, the base 24 and either the lid 26 or insert 44 include markings to indicate to an operator the orientation of the lid 26 relative to the base 24 to ensure a proper fit when installing the lid 26 on the base 24.

With reference again to FIG. 2, a removable cover 52 is generally arranged adjacent the second end 38 of the lid 26. In one embodiment, the cover 52 is formed from a plastic or metallic sealing material and includes an exposed pull tab 54. A portion of the removable cover 52 may extend over the second end 38 and along the second portion 36 of the lid 26. The pull tab 54 is configured to separate from the remainder of the cover 52 to expose the second end 38 of the lid 26 when a force is applied thereto. In another embodiment, the cover 52 includes a screw top configured to threadably couple to the second end 38 of the lid 26 (FIG. 3). A partition 56, such as a disk fabricated from a cork, wood, or heat-resistant material for example, may be positioned near the junction of the first portion 32 and the second portion 36 of the lid 26 to form a compartment 58 within the second portion 36.

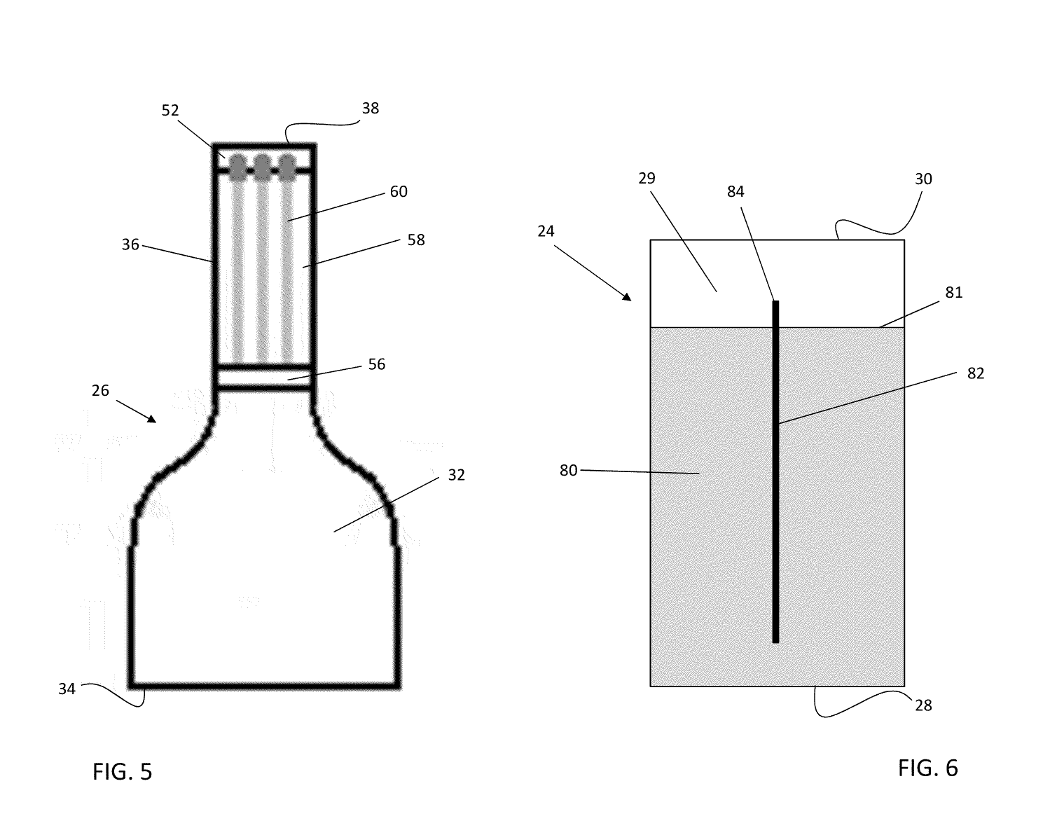

The compartment 58 may be configured to store a component related to the candle container 20, such as a note including a customizable message for example. In one embodiment, a plurality of matches 60 are arranged within the compartment 58 in the second portion 36 of the lid 26 (FIG. 5). The matches 60 are contained within the area defined by the compartment 58 until the pull tab is actuated, or the screw top is removed and the second end 38 is exposed. In addition, as illustrated in FIG. 2, a striking material 62 generally configured for use with one of the plurality of matches 60 may be adhered to the exterior of the housing 22 of the candle container 20, such as adjacent the compartment 58 for example. The striking material 62 may be arranged as a small strip having a narrow width, or alternatively, may be configured to wrap at least partially about the circumference of the second portion 36 of the lid 26. In other non-limiting embodiments, the striking material 62 may be positioned in other areas, such as but not limited to inside the compartment 58, on an inner portion of the cover 52, on the bottom 28 or a separate article disposed inside that compartment 58 for example.

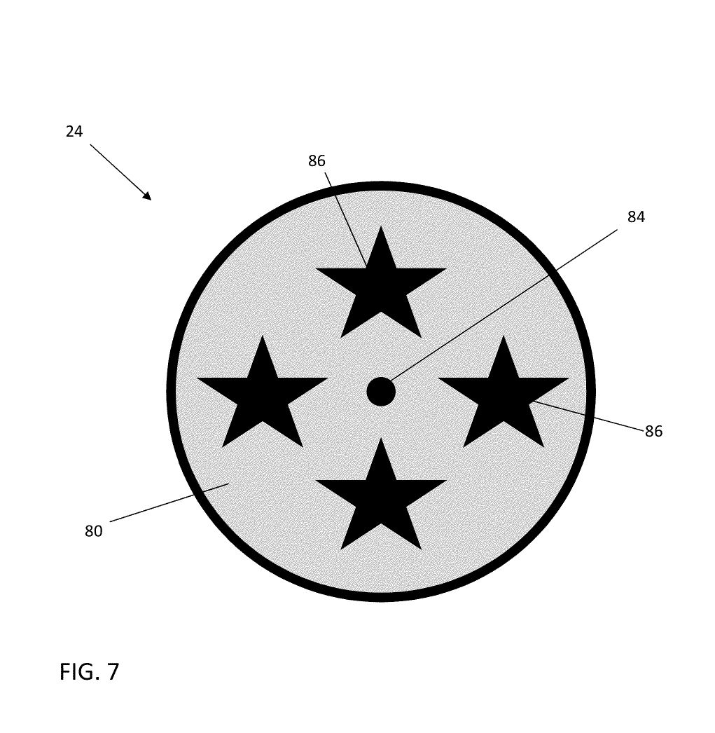

Referring now to FIGS. 6 and 7, a wax based candle 80 may be positioned within the cavity 29 of the base 24 such that an exposed end 84 of the candle wick 82 is arranged adjacent the open second end 30 (see FIG. 3). The length of the wick 82 will vary with the candle 80 to prevent the base 24 from overheating. The candle 80 may have a diameter less than the diameter of the cavity 29 and may be removably located therein. Alternatively, the candle 80 may be formed integrally with the base 24, adjacent the first end 28, such as by pouring hot wax into the cavity 29 for example.

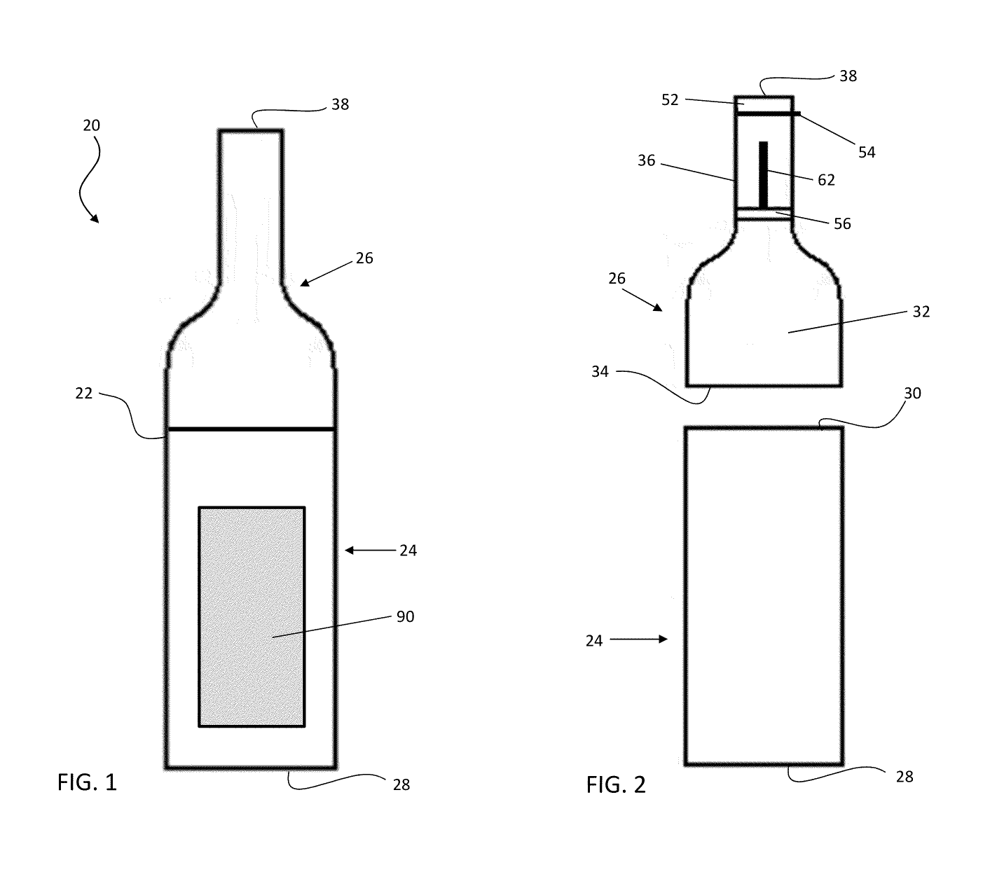

In one non-limiting embodiment shown in FIG. 7, one or more shapes 86 may be formed within the candle 80 and/or may extend from the surface 81 of the candle 80. Exemplary shapes include, but are not limited to, words, symbols, and holiday related shapes such as snowflakes, shamrocks, stars, hearts, flags, and trees for example. The candle 80 may be any color or any combination thereof. In one embodiment, the color and scent of the candle 80 are generally complementary to the candle container 20. For example, if the candle container 20 is formed from a recycled champagne bottle, the candle 80 may be generally beige colored with a champagne scent. Similarly, if the candle container 20 is formed from a recycled merlot bottle, the candle 80 may be generally red in color and have a wine, more particularly, a merlot scent. In addition, one or more labels 90, such as to indicate a brand and/or scent of the candle 20, or a warning for example, may be arranged about the exterior of the housing 22 (FIG. 1).

To form the candle container 20, a recycled bottle or housing 22 is cut into a complementary base 24 and lid 26. Once the housing 22 is separated, a candle is positioned within the cavity 29 of the base 24, and an insert 44 is mounted adjacent the first end 34 of the lid 26. A partition 56 is positioned between the first portion 32 and the second portion 36 of the lid 26 to create a compartment 58 within the second portion 36. A plurality of matches 60 are inserted into the compartment and a cover 52 is positioned at the second end 38 of the lid 26 to seal the matches 60 within the compartment. In addition, a striking material 62 and/or one or more labels 90 are fastened to the exterior of the housing 22.

By forming the base 24 and lid 26 of a candle container 20 from a bottle, the candle container 20 is configured to appear as a seamless bottle, thereby improving the aesthetic appeal of the candle container 20 when the candle 80 is not in use. In addition, because portions of the candle container 20 are customizable, such as the labels 90 or the appearance and scent of the candle 80 for example, the candle container 20 may be used in commercial applications. Exemplary commercial applications include, but are not limited to, use by vineyards and distilleries, use by businesses as marketing tools, or use as gifts at events such as a wedding for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A candle container, comprising
a generally hollow cylindrical base having a cavity configured to retain a candle;
a lid, removably coupled to the base the lid having a first portion adjacent a first end and a second portion near a second end, the first portion being generally complementary to the base; and
an insert adhered to an interior surface of the first portion of the lid and extending generally beyond a first end of the lid such that when the lid is attached to the base, a portion of the seal is received within the cavity of the base.

2. The candle container according to claim 1, wherein the first portion of the lid is a generally semi-circular shape and the second portion of the lid is a generally narrow cylinder.

3. The candle container according to claim 2, wherein the base and lid are generally formed from a bottle.

4. The candle container according to claim 3, wherein when the lid is attached to the base, the candle container is configured to appear as an uncut bottle.

5. The candle container according to claim 1, wherein the insert is configured to vertically align the lid and the base.

6. The candle container according to claim 1, wherein the insert includes at least one outwardly extending protrusion configured to contact a surface of the base and operably couple the lid to the base.

7. The candle container according to claim 1, wherein the base and at least one of the lid and insert include complementary markings configured to indicate an orientation of the lid relative to the base when the lid is attached to the base.

8. A candle container, comprising:
a housing including a generally hollow cylindrical base having a cavity configured to receive a candle, and a lid, removably coupled to the base, the lid having a first portion adjacent a first end and a second portion near a second end, the first portion being generally complementary to the base;
a removable cover coupled to the second end of the lid; and
a partition arranged between the first portion and the second portion of the lid such that a generally hollow compartment exists between the partition and the second end of the lid.

9. The candle container according to claim 8, wherein at least one match is arranged within the compartment.

10. The candle container according to claim 8, wherein a note is arranged within the compartment.

11. The candle container according to claim 8, wherein a striking material is fastened to a portion of the housing.

12. The candle container according to claim 8, wherein the cover adjacent the second end includes a pull tab configured to separate from the cover when a force is applied thereto.

13. The candle container according to claim 8, wherein the cover includes a cap configured to threadably engage the second end of the lid.

14. The candle container according to claim 8, wherein the first portion of the lid is a generally semi-circular shape and the second portion of the lid is a generally narrow cylinder.

15. The candle container according to claim 14, wherein the base and lid are generally formed from a bottle.

16. A method of manufacturing a candle container, comprising:
cutting a bottle into a base and a lid having a first portion and a second portion;
arranging a candle within a cavity of the base; and
mounting an insert to the first portion of the lid.

17. The method according to claim 16, wherein the candle is integrally formed within the cavity of the base.

18. The method according to claim 16, further comprising:
inserting a partition between the first portion and the second portion of the lid such that a generally hollow compartment exists between the partition and a sealed second end of the lid.

19. The method according to claim 18, wherein at least one match is positioned within the compartment.

20. The method according to claim 18, further comprising:
fastening a striking material and at least one label about the exterior of the candle container.
